(19) United States
(12) Patent Application Publication
(10) Pub. No.: US 2025/0088947 A1
(43) Pub. Date: Mar. 13, 2025

(54) DETERMINING SLICE SUPPORT OF A NEIGHBORING CELL

(71) Applicant: Lenovo (Singapore) Pte. Ltd., New Tech Park (SG)

(72) Inventor: Prateek Basu Mallick, Dreieich (DE)

(21) Appl. No.: 18/725,524

(22) PCT Filed: Feb. 27, 2023
(86) PCT No.: PCT/IB2023/051827

§ 371 Date: Jun. 28, 2024

Related U.S. Application Data
(60) Provisional application No. 63/314,359, filed on Feb. 25, 2022.

(51) Int. Cl. H04W 48/16; H04W 48/10

(52) U.S. Cl. CPC H04W 48/16; H04W 48/10

(57) ABSTRACT

Apparatuses, methods, and systems are disclosed for identifying slice support information of a neighbor cell. One method includes receiving an indication of at least one frequency and at least one slice group corresponding to the at least one frequency. The method includes receiving, for each of the at least one frequency, a list of PCIs associated with a respective slice group, where the received list of PCIs comprises a list of allowed cells or a list of blocked cells. The method includes determining slice support of a set of neighboring cells based on the list of PCIs.

### CROSS-REFERENCE TO RELATED APPLICATIONS

This application claims priority to U.S. Provisional Patent Application No. 63/314,359 entitled “SIGNALING NEIGHBOR CELLS SUPPORTING NETWORK SLICES” and filed on 25 Feb. 2022 for Prateek Basu Mallick, which application is incorporated herein by reference.

### FIELD

The subject matter disclosed herein relates generally to wireless communications and more particularly relates to signaling slice support information of neighboring cells.

### BACKGROUND

One of the new features introduced in the Third Generation Partnership Project (“3GPP”) Fifth Generation (“5G”) communication system is the support of network slicing. A “network slice” refers to a portion of a mobile communication network optimized for a certain traffic type or communication service. A network slice instance may be identified by a single-network slice selection assistance information (“S-NSSAI”).

### BRIEF SUMMARY

Disclosed are solutions for identifying slice support information of a neighbor cell. Said solutions may be implemented by apparatus, systems, methods, and/or computer program products.

One method at a user equipment (“UE”) includes receiving, from a serving cell, an indication of at least one frequency and at least one slice group corresponding to the at least one frequency. The method includes receiving, for each of the at least one frequency, a list of Physical Cell Identities (“PCIs”) supporting a combination of a respective frequency and a respective slice group, where the received list comprises one of a list of allowed cells or a list of blocked cells. The method includes determining slice support of neighboring cells based on the list of PCIs.

One method at a network entity includes transmit an indication of at least one frequency and at least one slice group corresponding to the at least one frequency. The method includes broadcasting, for each of the at least one frequency, a list of PCIs supporting a combination of a respective frequency and a respective slice group, where the list of PCIs comprises one of a list of allowed cells or a list of blocked cells.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for identifying slice support information of a neighbor cell;

FIG. 2 is a block diagram illustrating one embodiment of a New Radio (“NR”) protocol stack;

FIG. 3 is a diagram illustrating one embodiment of cell and frequency deployment;

FIG. 4A is a diagram illustrating one embodiment of a cell information table organized according to slice group;

FIG. 4B is a diagram illustrating another embodiment of a cell information table organized according to slice group;

FIG. 5A is a diagram illustrating one embodiment of a cell information table organized according to frequency;

FIG. 5B is a diagram illustrating another embodiment of a cell information table organized according to frequency;

FIG. 6 is a diagram illustrating one embodiment of an Abstract Syntax Notation 1 (“ASN.1”) implementation of cell list information element (“IE”);

FIG. 7 is a diagram illustrating one embodiment of an ASN.1 implementation of a cell list IE;

FIG. 8A is a diagram illustrating one embodiment of a procedure for identifying slice support information of a neighbor cell;

FIG. 8B is a diagram illustrating one embodiment of delivery mechanisms for contents of a cell information table;

FIG. 9 is a block diagram illustrating one embodiment of a user equipment apparatus that may be used for identifying slice support information of a neighbor cell;

FIG. 10 is a block diagram illustrating one embodiment of a network apparatus that may be used for identifying slice support information of a neighbor cell;

FIG. 11 is a flowchart diagram illustrating one embodiment of a first method for identifying slice support information of a neighbor cell; and

FIG. 12 is a flowchart diagram illustrating one embodiment of a second method for identifying slice support information of a neighbor cell.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “at least one of A, B and C” includes only A, only B, only C, a combination of A and B, a combination of B and C, a combination of A and C or a combination of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for identifying slice support information of a neighbor cell. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In 3GPP, a mobile communication network (i.e., comprising radio access network (“RAN”) and/or core network (“CN”) may indicate a list of Physical Cell Identities (referred to as a “PCI list”). In one embodiment, the PCI list may correspond to a block-list, i.e., a list of at least one Physical Cell Identity (“PCI”) corresponding to cell(s) that do not support a corresponding slice group. In another embodiment, the PCI list may correspond to an allow-list, i.e., a list of at least one PCI corresponding to cell(s) that support the corresponding slice group. However, current specification and agreements do not describe nor suggest how the UE it to treat a detected cell that is not in a block-list or allow-list.

As one possibility, the network shall provide an exhaustive list of neighboring cells in both allow-list and block-list. However, this solution may result in needlessly high signaling overhead, especially since broadcasting is to be used. Accordingly, the network may reduce signaling overhead by transmitting only a block-list or only an allow-list, e.g., for a particular combination of carrier frequency and slice group, wherein the UE is configured to determine whether an unlisted cell (i.e., a detected cell for which the corresponding PCI is not listed in the block-list (alternatively, not listed in the allow-list).

In some embodiments, the network (e.g., a serving cell) broadcasts one or both lists (allow and block) for one frequency and slice group combination. In addition, another IE (e.g., called “detected-cell”) is also signaled. This additional IE explicitly informs the UE if any detected cell is to be treated as allowed cell, blocked cell or if the UE must read the corresponding cell's System Information Block #1 (“SIB1”) to find out itself.

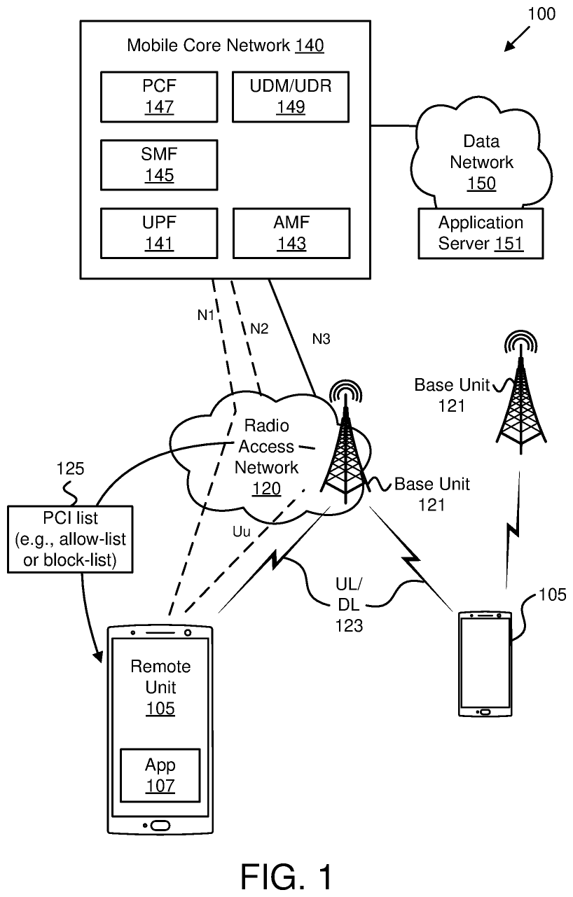

FIG. 1 depicts a wireless communication system 100 for identifying slice support information of a neighbor cell, according to embodiments of the disclosure. In one embodiment, the wireless communication system 100 includes at least one remote unit 105, a RAN 120, and a mobile core network 140. The RAN 120 and the mobile core network 140 form a mobile communication network. The RAN 120 may be composed of a base station unit 121 with which the remote unit 105 communicates using wireless communication links 123. Even though a specific number of remote units 105, base station units 121, wireless communication links 123, RANs 120, and mobile core networks 140 are depicted in FIG. 1, one of skill in the art will recognize that any number of remote units 105, base station units 121, wireless communication links 123, RANs 120, and mobile core networks 140 may be included in the wireless communication system 100.

In one implementation, the RAN 120 is compliant with the 5G system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above). The remote unit 105 allows a user to access network services. In various embodiments, the interface between the remote unit 105 and the network is the radio interface. The remote unit 105 may be subdivided into a number of domains, the domains being separated by reference points. For example, the remote unit 105 may be subdivided into the Universal Integrated Circuit Card (“UICC”) domain and the ME Domain. The ME Domain can further be subdivided into one or more Mobile Termination (“MT”) and TE components, with connectivity between multiple functional groups.

The remote units 105 may communicate directly with one or more of the base station units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication links (not depicted in FIG. 1) comprising one or more sidelink channels, such as the Physical Sidelink Control Channel (“PSCCH”), the Physical Sidelink Shared Channel (“PSSCH”), and/or Physical Sidelink Feedback Channel (“PSFCH”). Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframes, slots, subslots, etc.). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”) (not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base station units 121 may be distributed over a geographic region. In certain embodiments, a base station unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a gNB, a Home Node-B, a relay node, a RAN node, or by any other terminology used in the art. The base station units 121 are generally part of a RAN, such as the RAN 120, that may include one or more controllers communicably coupled to one or more corresponding base station units 121. These and other elements of radio access network are not illustrated but are well known generally by those having ordinary skill in the art. The base station units 121 connect to the mobile core network 140 via the RAN 120.

The base station units 121 may serve a number of remote units 105 within a serving area, for example, a cell or a cell sector, via a wireless communication link 123. The base station units 121 may communicate directly with one or more of the remote units 105 via communication signals. Generally, the base station units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base station units 121.

Note that during NR operation on unlicensed spectrum (referred to as “NR-U”), the base station unit 121 and the remote unit 105 communicate over unlicensed (i.e., shared) radio spectrum. Similarly, during LTE operation on unlicensed spectrum (referred to as “LTE-U”), the base station unit 121 and the remote unit 105 also communicate over unlicensed (i.e., shared) radio spectrum. For operation in unlicensed spectrum (e.g., NR-U or LTE-U), when a remote unit 105 or base station unit 121 wants to transmit, it has to detect the energy level at a designated time for duration equal to a Clear Channel Assessment (“CCA”) period. If the energy level in the channel is below the CCA threshold, then the equipment can transmit for duration equal to a (i.e., predefined) Channel Occupancy Time (“COT”). After that, if the equipment wishes to continue its transmission, it has to repeat the CCA process.

In one embodiment, the mobile core network 140 is a 5G core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”) (also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling. NAS ciphering and integrity protection, registration management, connection management, mobility management, access authentication and authorization, security context management.

The SMF 146 is responsible for session management (i.e., session establishment, modification, release), remote unit (i.e., UE) Internet Protocol (“IP”) address allocation and management, DL data notification, and traffic steering configuration of the UPF 141 for proper traffic routing. The RAN 120 configures the remote unit 105 using radio resource control (“RRC”) protocol over the Uu interface (e.g., LTE-Uu and/or NR-Uu). The PCF 147 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a S-NSSAI while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 146 and UPF 141. In some embodiments, the different network slices may share some common network functions, such as the AMF 143. The different network slices are not shown in FIG. 1 for ease of illustration, but their support is assumed. Where different network slices are deployed, the mobile core network 140 may include a Network Slice Selection Function (“NSSF”) which is responsible for selecting of the Network Slice instances to serve the remote unit 105, determining the allowed NSSAI, determining the AMF set to be used to serve the remote unit 105.

The solutions described herein enable the mobile core network 140 to identifying slice support information of a neighbor cell using a PCI list 125. In one embodiments, base station unit 121 may be configured to transmit a set of one or more allow-lists to the remote unit 105. In another embodiment, base station unit 121 may be configured to transmit a set of one or more block-lists to the remote unit 105. In other embodiments, the base station unit 121 may be configured to transmit at least one allow-list and at least one block-list to the remote unit 105. In various embodiments, a remote unit 105 may be configured to determine slice support information for a set of (e.g., one or more) neighbor cells based on the PCI list(s) 125, as described in further detail below.

While FIG. 1 depicts components of a 5G RAN and a 5G core network, the described embodiments for identifying slice support information of a neighbor cell apply to other types of communication networks and RATs, including IEEE 802.11 variants, Global System for Mobile Communications (“GSM”) (i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 146 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-NB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc.

Further, the operations are described mainly in the context of 5G NR. However, the below described solutions/methods are also equally applicable to other mobile communication systems identifying slice support information of a neighbor cell.

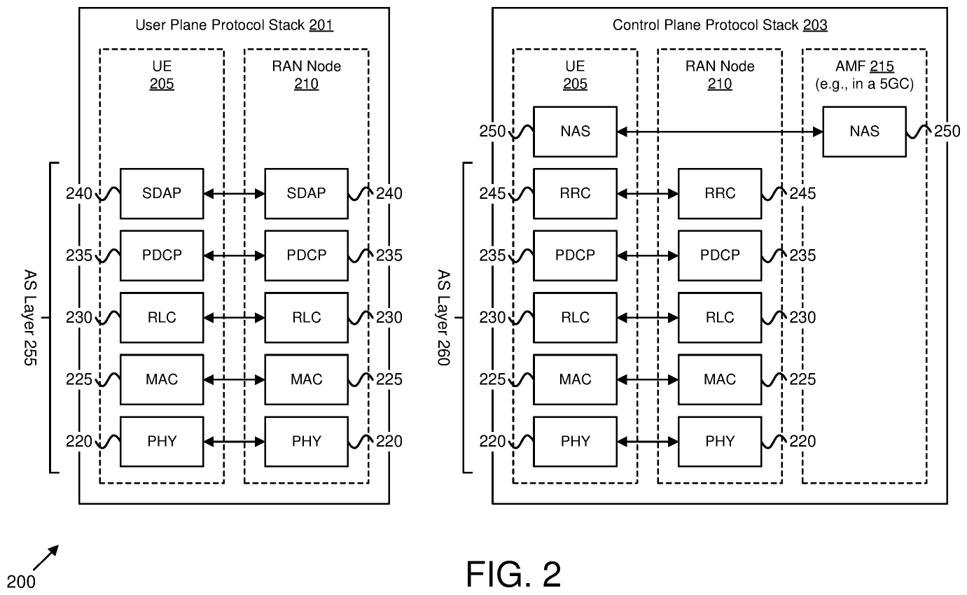

FIG. 2 depicts an NR protocol stack 200, according to embodiments of the disclosure. While FIG. 2 shows the UE 205, the RAN node 210 and an AMF 215, e.g., in a 5GC, these are representatives of a set of remote units 105 interacting with a base station unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes an RRC layer 245 and a NAS layer 250.

The Access Stratum (“AS”) layer 255 (also referred to as “AS protocol stack”) for the User Plane protocol stack 201 consists of at least SDAP. PDCP, RLC and MAC sublayers, and the physical layer. The AS layer 260 for the Control Plane protocol stack 203 consists of at least RRC. PDCP, RLC and MAC sublayers, and the physical layer. The Layer-1 (“L1”) consists of the PHY layer 220. The Layer-2 (“L2”) is split into the SDAP sublayer 240, PDCP sublayer 235, RLC sublayer 230, and MAC sublayer 225. The Layer-3 (“L3”) includes the RRC layer 245 and the NAS layer 250 for the control plane and includes, e.g., an IP layer and/or PDU Layer (not shown in FIG. 1) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a Clear Channel Assessment (“CCA”) and/or Listen-Before-Talk (“LBT”) procedure using energy detection thresholds. In certain embodiments, the PHY layer 220 may send an indication of beam failure to a MAC entity at the MAC sublayer 225. In certain embodiments, the PHY layer 220 may send a notification of Listen-Before-Talk (“LBT”) failure to a MAC entity at the MAC sublayer 235. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of PRBs, etc.

5G network slicing is a network architecture that enables the multiplexing of virtualized and independent logical networks on the same physical network infrastructure. Each network slice is an isolated end-to-end network tailored to fulfil diverse requirements requested by a particular application.

For this reason, this technology assumes a central role to support 5G mobile networks that are designed to efficiently embrace a plethora of services with quite different service level requirements (“SLR”). The realization of this service-oriented view of the network leverages on the concepts of software-defined networking (“SDN”) and network function virtualization (“NFV”) that allow the implementation of flexible and scalable network slices on top of a common network infrastructure.

Strong demand in wireless communication is expected in vertical markets, as connectivity and mobility empower the transformation and innovation in industries such as manufacturing, transportation, energy and civil services, healthcare, and many more. These diverse vertical services bring about a wide range of performance requirements in throughput, capacity, latency, mobility, reliability, position accuracy, etc. NR technology promises a common RAN platform to meet the challenges of current and future use cases and services. As such network slicing may be used to achieve more flexibility and higher scalability for a multitude of services of disparate requirements. Accordingly, future networks are expected to support slice-based cell reselection.

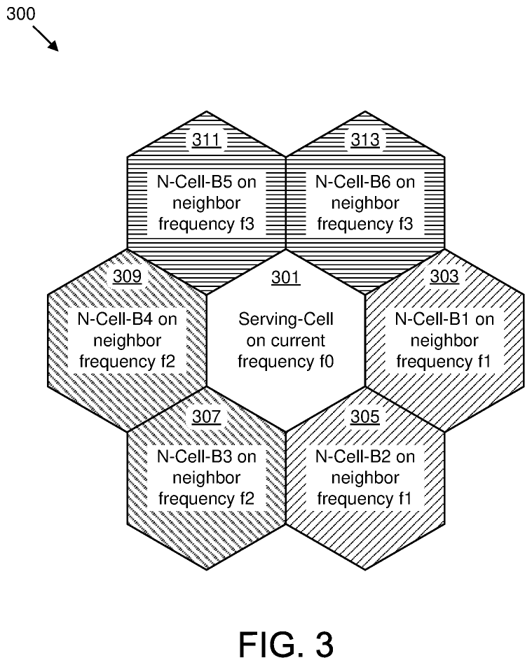

FIG. 3 depicts example of cell and frequency deployment 300, according to embodiments of the disclosure. The cell and frequency deployment 300 includes a serving cell 301 operating on a carrier frequency ‘f0’ and a plurality of neighboring cells operating on other carrier frequencies, including a first neighboring cell 303 (denoted as “N-Cell-B1”) operating on carrier frequency ‘f1’, a second neighboring cell 305 (denoted as “N-Cell-B2”) operating on carrier frequency ‘f1’, a third neighboring cell 307 (denoted as “N-Cell-B3”) operating on carrier frequency ‘f2’, a fourth neighboring cell 309 (denoted as “N-Cell-B4”) operating on carrier frequency ‘f2’, a fifth neighboring cell 311 (denoted as “N-Cell-B5”) operating on carrier frequency ‘f3’, and a sixth neighboring cell 313 (denoted as “N-Cell-B6”) operating on carrier frequency ‘f3’. While not depicted in FIG. 3, it is assumed that an instance of the UE 205 is located in the serving cell 301.

In the depicted deployment, the frequencies corresponding to the neighboring cells 303-313 do not necessarily support a same network slice (or slice group) as the current serving cell 301, e.g., as received from the NAS layer 250 in the UE 205.

During initialization, the UE 205 performs the cell selection process and acquires the basic network information. For example, at power up, the UE 205 searched for a cell to camp on. Camping on a cell means tuning to the control channels of that cell, thus enabling the UE 205 to receive broadcast messages transmitted by the cell. The UE 205 then performs the random access procedure to access the network via the selected cell and sets up a dedicated connection with the RAN node 210 (e.g., gNB). Once the connection is established, the UE 205 registers with the core network (e.g., 5GC) and performs an authentication procedure.

If the UE Access Stratum (e.g., corresponding to the AS layer 255 and/or the AS layer 260) receives at least one slice group information from the NAS layer 250, optionally with a corresponding priority for the slice group(s), it can start a slice group based cell reselection to ensure that it reselects to a cell that support a highest/higher priority slice group indicated by the NAS layer 250.

During the cell selection process, the UE 205 sequentially scans the radio frequency (“RF”) bands that it supports. This band scanning enables the UE to find the active RF carriers (e.g., frequencies for which the received signal strength indicator (“RSSI”) exceeds a certain threshold). The UE 205 determines a cell's physical layer identity and physical cell identity group. The physical cell identity group together with the physical layer identity provides the unambiguous PCI. In various embodiments, the cell search and cell selection conform with the standards described in 3GPP Technical Specification (“TS”) 38.133 and 38.304.

To assist with slice-based cell reselection, a serving cell may broadcast the supported slice information of the current cell and of neighbor cells, e.g., in a system information message. The serving cell may also broadcast cell reselection priority per slice, e.g., in a system information message. In some embodiments, a RAN may include slice information (with similar information as in the above described system information messages) to a UE in a RRCRelease message, e.g., to assist with slice-based cell reselection.

In some embodiments, a UE 205 determines the frequency priority order according to the following rules:
a. Considering the slice/slice-group priority provided by NAS, the frequencies that support higher priority slice/slice-group have higher slice-based frequency priority than the frequencies that support lower priority slice/slice-group;
b. Among the frequencies supporting a slice/slice-group with the same priority, the UE 205 is to follow the slice-specific frequency priority received in a System Information Block (“SIB”) or RRCRelease message (if configured);
c. Among the frequencies supporting the same slice/slice-group, the frequency not configured with slice-specific reselection priority is to be considered as lower priority than other frequencies configured with slice-specific reselection priority;
d. The frequencies that support any slice/slice-group have higher slice-based frequency priority than the frequencies that support none of slice/slice-group;
e. For the frequencies that do not support any slice/slice-group, the UE is to follow the legacy cell reselection priority received in a SIB.

In some embodiments, if the UE 205 may be configured with slice-specific frequency priority via RRCRelease message, then the UE 205 ignores all the slice-specific priorities provided in system information. When the UE 205 is configured with slice-based dedicated priority, if the UE 205 cannot find a suitable cell using any cell reselection priorities (including slice-based priorities and legacy (i.e., non-slice-based) priorities), then the UE 205 may first enter any cell selection state and performs cell selection, e.g., as per legacy procedure.

In some embodiments, inter-RAT frequencies are not configured with slice-specific frequency priority, but inter-RAT frequencies can be considered using legacy cell reselection frequency priority after all NR frequencies that support any slice/slice-group. In some embodiments, the slice-specific cell reselection information provided by the network in SIB is slice group specific. In some embodiments, the legacy T320 timer is reused for slice-specific frequency priority in the RRCRelease message. In some embodiments, RAN-sharing may be supported for slice-based cell reselection and random access channel procedure (“RACH”) by network implementation (e.g., dedicated priorities in RRCRelease).

As one example implementation, a UE 205 selects the highest priority slice or slice group among the slice(s) and slice group(s) indicated by NAS, supported on at least one frequency present in the slice reselection information. For the selected slice (or slice group), the UE 205 assigns frequency priority to each of the selected slice's supporting frequency from the slice reselection information. As used herein, “slice reselection information” refers to information broadcasted by a serving cell, or received in an RRCRelease message on slice/slice-group support in neighboring frequencies and/or cells.

Then, starting with the highest priority frequency, for each supporting frequency of the selected slice or slice group, the UE 205 performs cell search and selects the highest ranked and suitable cell as candidate for camping. The UE 205 camps on the highest ranked and suitable cell if it supports the selected slice.

If no such cell is found, the UE 205 goes on to select the next lower priority slice or slice group among the slice(s) and slice group(s) priorities indicated by NAS, which is supported on at least one frequency present in the slice reselection information and repeats the procedure and while doing so, the UE 205 may use stored slice information and measurements from immediate past to minimize measurements.

For slice-based cell reselection, a UE 205 needs to ensure that a neighboring cell on a neighboring frequency actually supports the selected slice. This can be done by reading the SIB1 of the corresponding cell, but this will be too time and battery consuming if the UE 205 needs to read the SIB1 of many cells in a hit-and-trial manner. For this reason, the serving cell of the UE 205 can indicate the slice support information of the neighbor cells. In some embodiments, the network may indicate whether the PCI list is block-list (“cells not supporting the corresponding slice group”) or allow-list (“cells supporting the corresponding slice group”). Note that for detecting cell Id as PCI, the UE only needs to read the MIB of the cell (not the SIB1).

As used herein, “block-list” refers to a list of cells that do not support the slice-frequency combination. On the other hand, the “allow-list,” indicates cells that support slice-frequency combination. The term “slice support information” refers to information indicating whether or not a cell supports a particular slice/slice-group or a slice-frequency combination.

Moreover, in the below descriptions, it is assumed that the network only lists frequencies where at least one cell supports one or more network slice(s). The term “slice group” refers to a group of network slices having a common identifier. Accordingly, the term “slice” used in this document refers equally to a “slice group.” In certain embodiments, the term “slice/slice-group” is used to indicate a set of (i.e., one or more) network slices having a common identifier.

The present disclosure details solutions for signaling slice support information of neighbor cells. An overview of the solutions is presented as follows:

In a first solution, the network signals only one PCI list (i.e., allow-list or block-list) for one combination of frequency and slice/slice-group.

In a second solution, the network indicates whether a cell that is not included in an allow-list or block-list is to be treated as allowed cell or a blocked cell, or if the UE must read the corresponding cell's system information to determine whether or not the cell supports a particular slice/slice-group.

Note that the solutions described herein are not mutually exclusive. In fact, in various embodiments the solutions described herein may be implemented in combination with each other to signal neighbor cells supporting network slice groups.

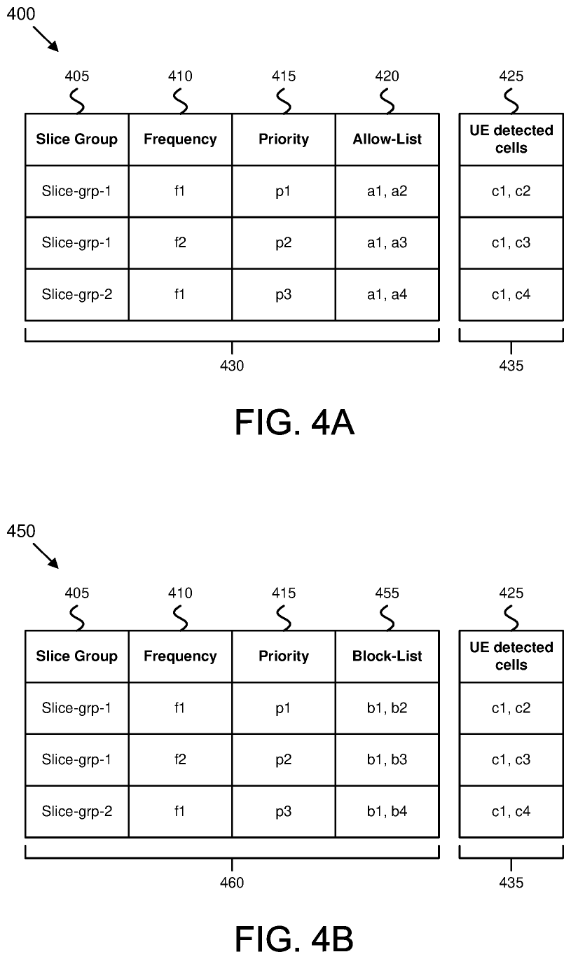

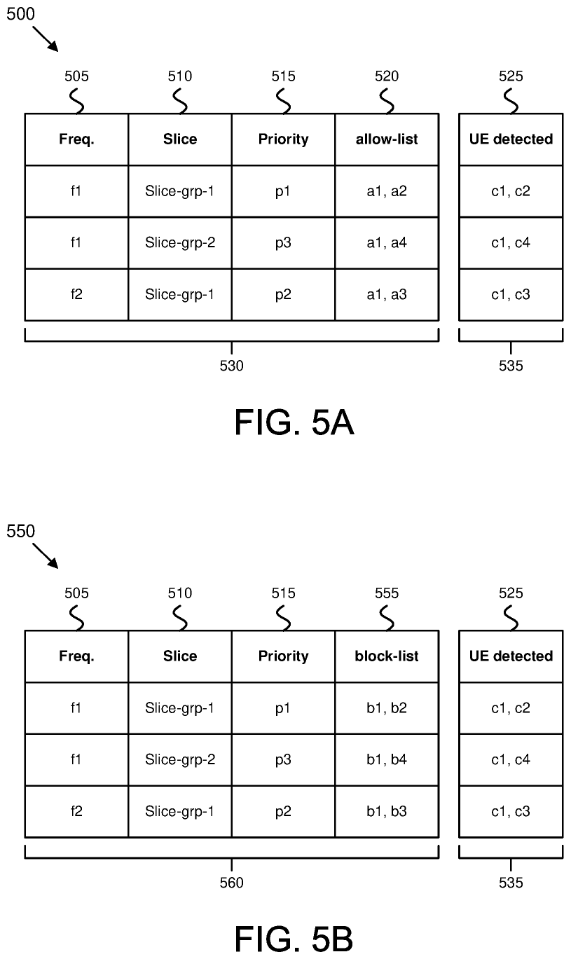

According to embodiments of the first solution, the network broadcasts only one list (allow or block) for one frequency and slice/slice-group combination (as shown in FIGS. 4A-4B and in FIGS. 5A-5B). So, for one combination it can indicate only blocked cell list and for another combination, only an allowed cell list, or vice-versa.

For example, if the network broadcasts only allow-list for a certain frequency and slice group combination, then the UE 205 assumes any cell not listed in the allow-list for the given combination does not support the corresponding slice/slice-group of the combination. In such a case detected cells (i.e., cells not listed in the allow-list) c1, c2 etc., do not support the corresponding frequency and slice group combination.

As another example, if the network broadcasts only block-list for a certain frequency and slice group combination, then the UE 205 assumes all cells not listed in the block-list for the given combination support the corresponding slice/slice-group of the combination. In such a case detected cells (i.e., cells not listed in the allow-list) c1, c2, etc., do support the corresponding frequency and slice group combination.

FIG. 4A depicts a cell information table 400 organized according to slice group, according to embodiments of the disclosure. The cell information table 400 includes a column 405 of slice group identities (denoted “Slice-grp-1”, “Slice-grp-2”, “Slice-grp-3”) and a column 410 of corresponding carrier frequencies (denoted “f1”, “f2”). Here, each row of the cell information table 400 represents a unique combination of slice group identity and carrier frequency. In the depicted embodiment, the cell information table 400 includes a column 415 of priority values (denoted “p1”, “p2”, “p3”). However, in other embodiments the column 415 of priority values may be absent and corresponding priority values for each row of the cell information table 400 may be implicitly signaled from the order of the cell information table 400.

Additionally, the cell information table 400 includes a column 420 of allow-lists (e.g., cells that support the corresponding slice-frequency combination). In the depicted embodiment, the column 420 indicates that cells ‘a1’ and ‘a2’ support Slice Group 1 on frequency ‘f1’, cells ‘a1’ and ‘a3’ support Slice Group 1 on frequency ‘f2’, and cells ‘a1’ and ‘a4’ support Slice Group 2 on frequency ‘f1’. Note that the values ‘a1,’ ‘a2,’ ‘a3,’ ‘a4’, are cell IDs, e.g., PCIs.

The cell information table 400 also includes a column 425 of neighboring cells detected by the UE 205 for which slice support information must be determined. In the depicted embodiment, the UE 205 detects nearby cells (e.g., neighboring cells) including the cells ‘c1,’ ‘c2,’ ‘c3,’ and ‘c4’, which are not listed in an allow-list. According to embodiments of the first solution, the UE 205 determines that the slice group connectivity is not supported for cells ‘c1,’ ‘c2’, ‘c3.’ and ‘c4’ for the corresponding combination of frequency and slice group. Note that the values ‘c1,’ ‘c2’, ‘c3,’ ‘c4’, are cell IDs, e.g., PCIs.

For the depicted cell information table 400, the information 430 (e.g., comprising columns 405, 410, 415, and 420) is configured to the UE 205 by the network (e.g., the RAN node 210), while the information 435 is UE derived (e.g., by performing signal measurement). In various embodiments, the allow-lists are broadcast from a RAN node 210 in a current serving cell (e.g., serving cell 301) to a UE 205, e.g., via RRC broadcast signaling. In some embodiments, the slice group identities, corresponding frequencies, and (optional) priority values are broadcast from the RAN node 210 to a UE 205, e.g., via RRC broadcast signaling. In other embodiments, the slice group identities, corresponding frequencies, and (optional) priority values are sent to the UE 205 (from the RAN node 210) using dedicated RRC signaling.

As used herein, dedicated signaling refers to signaling via a network resource that is configured to only one UE and is generally not shared among multiple UEs, referred to as a “dedicated resource.” The signaling on dedicated resource(s) may be established by a configuration that is applicable to a single UEs, such as a parameter, e.g., in a user-specific, UE-specific, or device-specific configuration. It should however be noted that as an implementation choice, two different user-specific dedicated parameters indicating a dedicated resource may indicate the same dedicated resource.

In one embodiment, the UE 205 detects cells ‘a1,’ ‘a2,’ ‘c1’, and ‘c2’ that operate using frequency ‘f1.’ Here, it is assumed that the values ‘c1’ and ‘c2’ are different cell IDs than the values ‘a1’ and ‘a2’. Note, however, that the values ‘c1’ and ‘c2’ could be the same cell IDs as ‘a3’ or ‘a4’. From the signaled allow-list, the UE 205 knows that cells ‘a1’ and ‘a2’ support connectivity to Slice Group 1 on frequency ‘f1’; however, because cells ‘c1’ and ‘c2’ are not on the allow-list, the UE 205 determines that these cells do not support connectivity to Slice Group 1 on frequency ‘f1’.

In another embodiment, the UE 205 detects cells ‘a1,’ ‘a3,’ ‘c1,’ and ‘c3’ that operate using frequency ‘f2.’ Here, it is assumed that the values ‘c1’ and ‘c3’ are different cell IDs than the values ‘a1’ and ‘a3’. Note, however, that the values ‘c1’ and ‘c3’ could be the same cell IDs as ‘a2’ or ‘a4’. From the signaled allow-list, the UE 205 knows that cells ‘a1’ and ‘a3’ support connectivity to Slice Group 1 on frequency ‘f2’; however, because cells ‘c1’ and ‘c2’ are not on the allow-list, the UE 205 determines that these cells do not support connectivity to Slice Group 1 on frequency ‘f2’.

In yet another embodiment, the UE 205 detects cells ‘a1,’ ‘a4,’ ‘c1,’ and ‘c4’ that operate using frequency ‘f1.’ Here, it is assumed that the values ‘c1’ and ‘c4’ are different cell IDs than the values ‘a1’ and ‘a4’. Note, however, that the values ‘c1’ and ‘c2’ could be the same cell IDs as ‘a2’ or ‘a3’. From the signaled allow-list, the UE 205 knows that cells ‘a1’ and ‘a4’ support connectivity to Slice Group 2 on frequency ‘f1’; however, because cells ‘c1’ and ‘c4’ are not on the allow-list, the UE 205 determines that these cells do not support connectivity to Slice Group 2 on frequency ‘f1’.

FIG. 4B depicts a cell information table 450 organized according to slice group, according to embodiments of the disclosure. The cell information table 450 includes a column 405 of slice group identities, a column 410 of corresponding carrier frequencies, and a column 420 of allow-lists, which columns are substantially similar to those described above with reference to FIG. 4A. In the depicted embodiment, the cell information table 450 also includes optional column 415 of priority values; however, in other embodiments the column 415 of priority values may be absent from the cell information table 450 and the corresponding priority values implicitly determined, as described above.

Additionally, the cell information table 400 includes a column 455 of block-lists (e.g., cells that do not support the corresponding slice-frequency combination). In the depicted embodiment, the column 455 indicates that cells ‘b1’ and ‘b2’ do not support Slice Group 1 on frequency ‘f1’, cells ‘b1’ and ‘b3’ do not support Slice Group 1 on frequency ‘f2’, and cells ‘b1’ and ‘b4’ do not support Slice Group 2 on frequency ‘f1’. Note that the values ‘b1,’ ‘b2,’ ‘b3,’ ‘b4,’ are cell IDs, e.g., PCIs.

The cell information table 450 also includes a column 425 of neighboring cells detected by the UE 205 for which slice support information must be determined. In the depicted embodiment, the UE 205 detects nearby cells (e.g., neighboring cells) including the cells ‘c1,’ ‘c2,’ ‘c3’, and ‘c4,’ which are not listed in a block-list. According to embodiments of the first solution, the UE 205 determines that the slice group connectivity is supported for cells ‘c1,’ ‘c2’, ‘c3’, and ‘c4’ for the corresponding combination of frequency and slice group.

For the depicted cell information table 450, the information 460 (e.g., comprising columns 405, 410, 415, and 455) is configured to the UE 205 by the network (e.g., the RAN node 210), while the information 435 is UE derived (e.g., by performing signal measurement). In various embodiments, the block-lists are broadcast from a RAN node 210 in a current serving cell (e.g., serving cell 301) to a UE 205, e.g., via RRC broadcast signaling. As described above, the slice group identities, corresponding frequencies, and (optional) priority values may be signaled from the RAN node 210 to the UE 205 via RRC broadcast signaling or via dedicated RRC signaling.

In one embodiment, the UE 205 detects cells ‘b1,’ ‘b2,’ ‘c1,’ and ‘c2’ that operate using frequency ‘f1.’ Here, it is assumed that the values ‘c1’ and ‘c2’ are different cell IDs than the values ‘b1’ and ‘b2’. Note, however, that the values ‘c1’ and ‘c2’ could be the same cell IDs as ‘b3’ or ‘b4’. From the signaled block-list, the UE 205 knows that cells ‘b1’ and ‘b2’ do not support connectivity to Slice Group 1 on frequency ‘f1’; however, because cells ‘c1’ and ‘c2’ are not on the block-list, the UE 205 determines that these cells support connectivity to Slice Group 1 on frequency ‘f1’.

In another embodiment, the UE 205 detects cells ‘b1,’ ‘b3,’ ‘c1,’ and ‘c3’ that operate using frequency ‘f2.’ Here, it is assumed that the values ‘c1’ and ‘c3’ are different cell IDs than the values ‘b1’ and ‘b3’. Note, however, that the values ‘c1’ and ‘c3’ could be the same cell IDs as ‘b2’ or ‘b4’. From the signaled block-list, the UE 205 knows that cells ‘b1’ and ‘b3’ do not support connectivity to Slice Group 1 on frequency ‘f2’; however, because cells ‘c1’ and ‘c2’ are not on the block-list, the UE 205 determines that these cells support connectivity to Slice Group 1 on frequency ‘f2’.

In yet another embodiment, the UE 205 detects cells ‘b1,’ ‘b4,’ ‘c1,’ and ‘c4’ that operate using frequency ‘f1.’ Here, it is assumed that the values ‘c1’ and ‘c4’ are different cell IDs than the values ‘b1’ and ‘b4’. Note, however, that the values ‘c1’ and ‘c2’ could be the same cell IDs as ‘b2’ or ‘b3’. From the signaled block-list, the UE 205 knows that cells ‘b1’ and ‘b4’ do not support connectivity to Slice Group 2 on frequency ‘f1’; however, because cells ‘c1’ and ‘c4’ are not on the block-list, the UE 205 determines that these cells support connectivity to Slice Group 2 on frequency ‘f1’.

FIG. 5A depicts a cell information table 500 organized according to frequency, according to embodiments of the disclosure. The cell information table 500 includes a column 505 of carrier frequencies (denoted “f1”, “f2”) and a column 510 of corresponding slice group identities (denoted “Slice-grp-1”, “Slice-grp-2”, “Slice-grp-3”). Here, each row of the cell information table 500 represents a unique combination of slice group identity and carrier frequency. In the depicted embodiment, the cell information table 500 includes a column 515 of priority values (denoted “p1”, “p2”, “p3”). However, in other embodiments the column 515 of priority values may be absent and corresponding priority values for each row of the cell information table 500 may be implicitly signaled, e.g., from the order of the cell information table 500.

Additionally, the cell information table 500 includes a column 520 of allow-lists (e.g., cells that support the corresponding slice-frequency combination). In the depicted embodiment, the column 420 indicates that cells ‘a1’ and ‘a2’ support Slice Group 1 on frequency ‘f1’, cells ‘a1’ and ‘a3’ support Slice Group 1 on frequency ‘f2’, and cells ‘a1’ and ‘a4’ support Slice Group 2 on frequency ‘f1’. Note that the values ‘a1,’ ‘a2,’ ‘a3,’ ‘a4’, are cell IDs, e.g., PCIs.

The cell information table 400 also includes a column 525 of neighboring cells detected by the UE 205 for which slice support information must be determined. In the depicted embodiment, the UE 205 detects nearby cells (e.g., neighboring cells) including the cells ‘c1,’ ‘c2,’ ‘c3’, and ‘c4’, which are not listed in an allow-list. According to embodiments of the first solution, the UE 205 determines that the slice group connectivity is not supported for cells ‘c1,’ ‘c2,’ ‘c3,’ and ‘c4’ for the corresponding combination of frequency and slice group. Note that the values ‘c1,’ ‘c2’, ‘c3’, ‘c4’, are cell IDs, e.g., PCIs.

For the depicted cell information table 500, the information 530 (e.g., comprising columns 505, 510, 515, and 520) is provisioned to the UE 205 by the network (e.g., the RAN node 210), while the information 535 is UE derived (e.g., by performing signal measurement). In various embodiments, the allow-lists are broadcast from a RAN node 210 in a current serving cell (e.g., serving cell 301) to a UE 205, e.g., via RRC broadcast signaling. In some embodiments, the slice group identities, corresponding frequencies, and (optional) priority values are broadcast from the RAN node 210 to a UE 205, e.g., via RRC broadcast signaling. In other embodiments, the slice group identities, corresponding frequencies, and (optional) priority values are sent to the UE 205 (from the RAN node 210) using dedicated RRC signaling.

In one embodiment, the UE 205 detects cells ‘a1,’ ‘a2,’ ‘c1’, and ‘c2’ that operate using frequency ‘f1.’ Here, it is assumed that the values ‘c1’ and ‘c2’ are different cell IDs than the values ‘a1’ and ‘a2’. Note, however, that the values ‘c1’ and ‘c2’ could be the same cell IDs as ‘a3’ or ‘a4’. From the signaled allow-list, the UE 205 knows that cells ‘a1’ and ‘a2’ support connectivity to Slice Group 1 on frequency ‘f1’; however, because cells ‘c1’ and ‘c2’ are not on the allow-list, the UE 205 determines that these cells do not support connectivity to Slice Group 1 on frequency ‘f1’.

In another embodiment, the UE 205 detects cells ‘a1,’ ‘a3,’ ‘c1,’ and ‘c3’ that operate using frequency ‘f2.’ Here, it is assumed that the values ‘c1’ and ‘c3’ are different cell IDs than the values ‘a1’ and ‘a3’. Note, however, that the values ‘c1’ and ‘c3’ could be the same cell IDs as ‘a2’ or ‘a4’. From the signaled allow-list, the UE 205 knows that cells ‘a1’ and ‘a3’ support connectivity to Slice Group 1 on frequency ‘f2’; however, because cells ‘c1’ and ‘c2’ are not on the allow-list, the UE 205 determines that these cells do not support connectivity to Slice Group 1 on frequency ‘f2’.

In yet another embodiment, the UE 205 detects cells ‘a1,’ ‘a4,’ ‘c1,’ and ‘c4’ that operate using frequency ‘f1.’ Here, it is assumed that the values ‘c1’ and ‘c4’ are different cell IDs than the values ‘a1’ and ‘a4’. Note, however, that the values ‘c1’ and ‘c2’ could be the same cell IDs as ‘a2’ or ‘a3’. From the signaled allow-list, the UE 205 knows that cells ‘a1’ and ‘a4’ support connectivity to Slice Group 2 on frequency ‘f1’; however, because cells ‘c1’ and ‘c4’ are not on the allow-list, the UE 205 determines that these cells do not support connectivity to Slice Group 2 on frequency ‘f1’.

FIG. 5B depicts a cell information table 550 organized according to frequency, according to embodiments of the disclosure. The cell information table 550 includes a column 505 of carrier frequencies, a column 510 of corresponding slice group identities, and a column 520 of allow-lists, which columns are substantially similar to those described above with reference to FIG. 5A. In the depicted embodiment, the cell information table 550 also includes optional column 515 of priority values; however, in other embodiments the column 515 of priority values may be absent from the cell information table 550 and the corresponding priority values implicitly determined, as described above.

Additionally, the cell information table 500 includes a column 555 of block-lists (e.g., cells that do not support the corresponding slice-frequency combination). In the depicted embodiment, the column 555 indicates that cells ‘b1’ and ‘b2’ do not support Slice Group 1 on frequency ‘f1’, cells ‘b1’ and ‘b3’ do not support Slice Group 1 on frequency ‘f2’, and cells ‘b1’ and ‘b4’ do not support Slice Group 2 on frequency ‘f1’. Note that the values ‘b1,’ ‘b2,’ ‘b3,’ ‘b4,’ are cell IDs, e.g., PCIs.

The cell information table 550 also includes a column 525 of neighboring cells detected by the UE 205 for which slice support information must be determined. In the depicted embodiment, the UE 205 detects nearby cells (e.g., neighboring cells) including the cells ‘c1,’ ‘c2,’ ‘c3,’ and ‘c4,’ which are not listed in a block-list. According to embodiments of the first solution, the UE 205 determines that the slice group connectivity is supported for cells ‘c1,’ ‘c2’, ‘c3’, and ‘c4’ for the corresponding combination of frequency and slice group.

For the depicted cell information table 550, the information 560 (e.g., comprising columns 505, 510, 515, and 555) is configured to the UE 205 by the network (e.g., the RAN node 210), while the information 535 is UE derived (e.g., by performing signal measurement). In various embodiments, the block-lists are broadcast from a RAN node 210 in a current serving cell (e.g., serving cell 301) to o a UE 205, e.g., via RRC broadcast signaling. As described above, the slice group identities, corresponding frequencies, and (optional) priority values may be signaled from the RAN node 210 to the UE 205 via RRC broadcast signaling or via dedicated RRC signaling.

In one embodiment, the UE 205 detects cells ‘b1,’ ‘b2,’ ‘c1,’ and ‘c2’ that operate using frequency ‘f1.’ Here, it is assumed that the values ‘c1’ and ‘c2’ are different cell IDs than the values ‘b1’ and ‘b2’. Note, however, that the values ‘c1’ and ‘c2’ could be the same cell IDs as ‘b3’ or ‘b4’. From the signaled block-list, the UE 205 knows that cells ‘b1’ and ‘b2’ do not support connectivity to Slice Group 1 on frequency ‘f1’; however, because cells ‘c1’ and ‘c2’ are not on the block-list, the UE 205 determines that these cells support connectivity to Slice Group 1 on frequency ‘f1’.

In another embodiment, the UE 205 detects cells ‘b1,’ ‘b3,’ ‘c1,’ and ‘c3’ that operate using frequency ‘f2.’ Here, it is assumed that the values ‘c1’ and ‘c3’ are different cell IDs than the values ‘b1’ and ‘b3’. Note, however, that the values ‘c1’ and ‘c3’ could be the same cell IDs as ‘b2’ or ‘b4’. From the signaled block-list, the UE 205 knows that cells ‘b1’ and ‘b3’ do not support connectivity to Slice Group 1 on frequency ‘f2’; however, because cells ‘c1’ and ‘c2’ are not on the block-list, the UE 205 determines that these cells support connectivity to Slice Group 1 on frequency ‘f2’.

In yet another embodiment, the UE 205 detects cells ‘b1,’ ‘b4,’ ‘c1,’ and ‘c4’ that operate using frequency ‘f1.’ Here, it is assumed that the values ‘c1’ and ‘c4’ are different cell IDs than the values ‘b1’ and ‘b4’. Note, however, that the values ‘c1’ and ‘c2’ could be the same cell IDs as ‘b2’ or ‘b3’. From the signaled block-list, the UE 205 knows that cells ‘b1’ and ‘b4’ do not support connectivity to Slice Group 2 on frequency ‘f1’; however, because cells ‘c1’ and ‘c4’ are not on the block-list, the UE 205 determines that these cells support connectivity to Slice Group 2 on frequency ‘f1’.

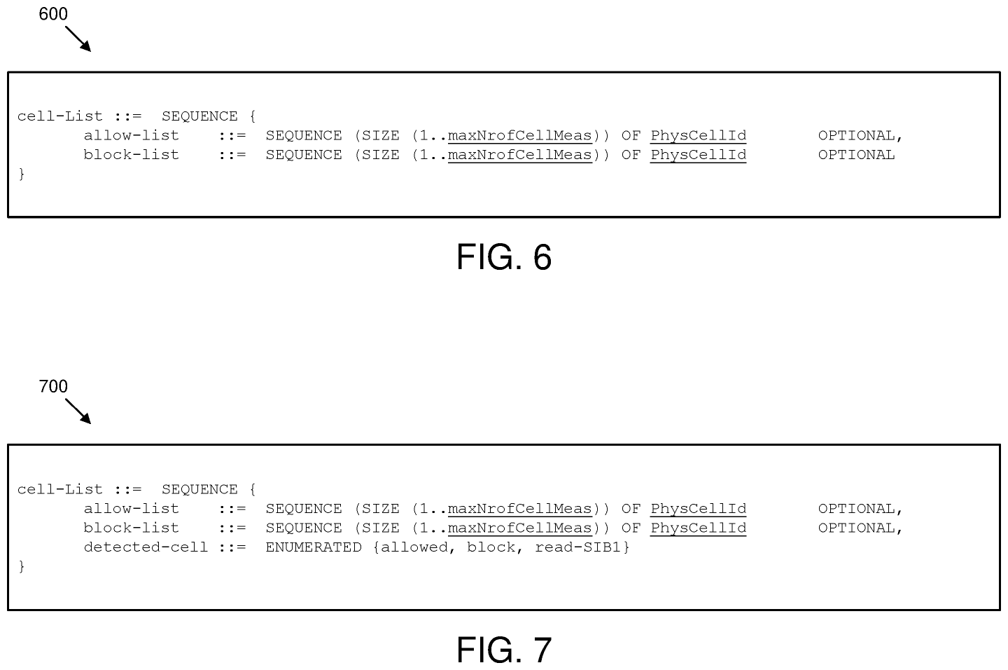

FIG. 6 depicts an exemplary ASN.1 structure of a cell list IE 600 that may be used to implement the first solution. In one embodiment, the cell list IE contains an allow-list. In another embodiment, the cell list IE contains a block-list. In some embodiments, the cell list IE 600 may contain an allow-list for a first set of cell IDs and contain a block-list for a different set of cell IDs.

According to embodiments of the second solution, the network broadcasts one or both lists (allow and block) for one frequency and slice/slice-group combination. In addition, another parameter is also signaled (called “detected-cell” in the example of FIG. 7). This additional parameter explicitly informs the UE 205 how to handle a detected cell that is not on a block-list or allow-list. In one embodiment, such a detected cell is to be treated as allowed cell. In another embodiment, such a detected cell is to be treated as a blocked cell. In other embodiments, the additional parameter indicates that for any detected cell not included in a block list or allow-list, the UE 205 is to read the corresponding cell's system information (e.g., SIB1) to determine the slice support information for that cell.

FIG. 7 depicts an exemplary ASN.1 structure of a cell list IE 700 that may be used to implement the second solution. In one embodiment, the cell list IE contains either an allow-list or a block-list. In another embodiment, the cell list IE contains both an allow-list and a block-list. In certain embodiments, the cell list IE 600 may contain an allow-list for a first set of cell IDs and contain a block-list for a different set of cell IDs. As noted above, the cell list includes a parameter (e.g., “detected-cell”) that explicitly informs the UE 205 how to handle a detected cell that is not on the included list(s) for a particular frequency and slice/slice-group combination.

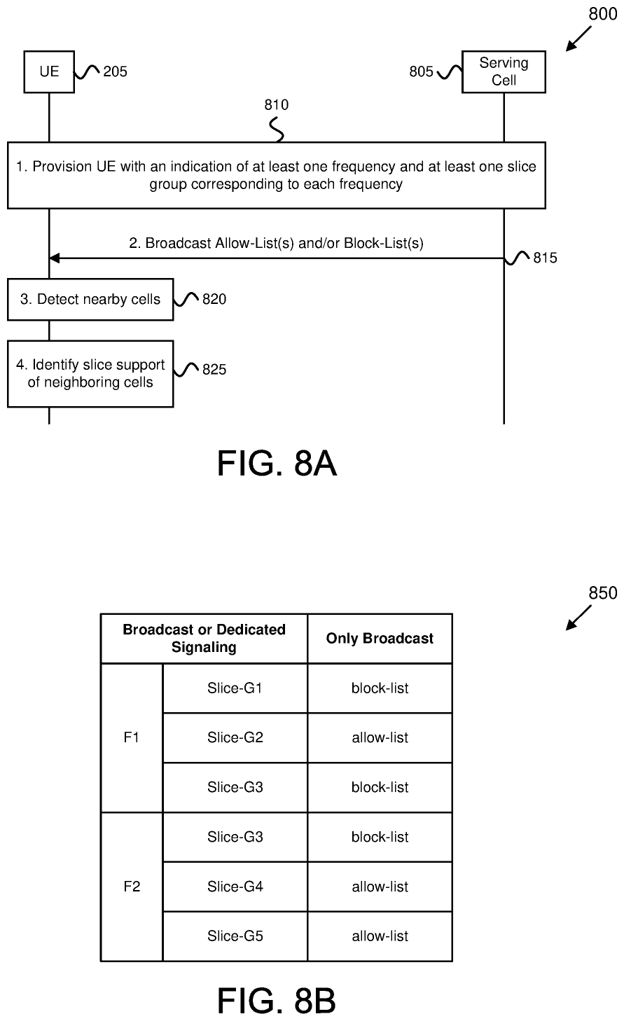

FIG. 8A depicts an exemplary procedure 800 for identifying slice support information of a neighbor cell, according to embodiments of the disclosure. The procedure 800 involves the UE 205 and a serving cell 805 (e.g., an embodiment of the serving cell 301 comprising a base station unit 121 and/or the RAN node 210). As a prerequisite, is it assumed that the UE 205 is located in a serving area of the service cell 805 and that the serving cell 805 is a current serving cells of the UE 205.

At Step 1, the serving cell 805 provisions the UE 205 with an indication of at least one frequency and at least one slice group corresponding to each frequency (see block 810). In various embodiments, the serving cell 805 may provision the columns 405 and 410, or the columns 505 and 510, as described above in the examples depicted in FIGS. 4A-4B and 5A-5B.

At Step 2, the serving cell 805 broadcasts at least one allow-list and/or at least one block-list (see signaling 815). As discussed in the first solution, the serving cell 605 may broadcast a single list, i.e., an allow-list or a block list, for each unique combination of frequency and slice group. Alternatively, the serving cell may broadcast both an allow-list and a block-list for one or more combinations of frequency and slice group, as discussed in the second solution.

At Step 3, the UE 205 detects nearby cells (see block 820). In various embodiments, the UE 205 performs a cell search procedure (e.g., in conjunction with cell selection and/or cell reselection) to detect a nearby cell and obtain the corresponding PCI of the nearby cell.

At Step 4, the UE 205 identifies slice support information of neighboring cells, e.g., for each detected cell (see block 825). As described above, the UE 205 uses the received allow-list(s) and/or block-list(s) to determine whether a cell supports connectivity to a particular network slice group on a specific frequency.

FIG. 8B depicts a table 850 of delivery mechanisms for network-provided cell information, according to embodiments of the disclosure. The information that may be delivered via broadcast or dedicated signaling includes the operating frequency and the slice group identifiers. However, the allow-lists and/or block-lists are transmitted using broadcast signaling.

According to embodiments of a third solution, the network is permitted the flexibility to use the above first solution for certain frequency and slice/slice-group combination(s) and to use the above second solution for other frequency and slice/slice-group combination(s).

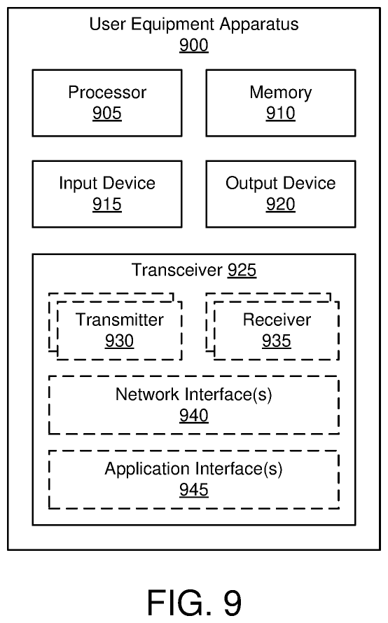

FIG. 9 depicts a user equipment apparatus 900 that may be used for identifying slice support information of a neighbor cell, according to embodiments of the disclosure. In various embodiments, the user equipment apparatus 900 is used to implement one or more of the solutions described above. The user equipment apparatus 900 may be one embodiment of a user endpoint, such as the remote unit 105 and/or the UE 205, as described above. Furthermore, the user equipment apparatus 900 may include a processor 905, a memory 910, an input device 915, an output device 920, and a transceiver 925.

In some embodiments, the input device 915 and the output device 920 are combined into a single device, such as a touchscreen. In certain embodiments, the user equipment apparatus 900 may not include any input device 915 and/or output device 920. In various embodiments, the user equipment apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. In some embodiments, the transceiver 925 communicates with one or more cells (or wireless coverage areas) supported by one or more base station units 121. In various embodiments, the transceiver 925 is operable on unlicensed spectrum. Moreover, the transceiver 925 may include multiple UE panels supporting one or more beams. Additionally, the transceiver 925 may support at least one network interface 940 and/or application interface 945. The application interface(s) 945 may support one or more APIs. The network interface(s) 940 may support 3GPP reference points, such as Uu, N1, PC5, etc. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the processor 905 controls the user equipment apparatus 900 to implement the above-described UE behaviors. In certain embodiments, the processor 905 may include an application processor (also known as “main processor”) which manages application-domain and operating system (“OS”) functions and a baseband processor (also known as “baseband radio processor”) which manages radio functions.

In various embodiments, via the transceiver 925, the processor 905 receives, from a serving cell, an indication of at least one frequency and at least one slice group corresponding to (e.g., each of) the at least one frequency. Additionally, via the transceiver 925, the processor 905 receives, for each of the at least one frequency, a list of PCIs supporting a combination of a respective frequency and a respective slice group, where the received list comprises one of a list of allowed cells or a list of blocked cells. The processor 905 determines slice support of neighboring cells based on the list of PCIs.

In some embodiments, the list of allowed cells indicates that the list of PCIs supports connectivity to the respective slice group using the respective frequency. In such embodiments, to determine the slice support of neighboring cells, the processor 905 may determine that a particular neighboring cell that is not included in the list of PCIs does not support connectivity to the respective slice group using the respective frequency.

In some embodiments, the list of blocked cells indicates that the list of PCIs does not support connectivity to the respective slice group using the respective frequency. In such embodiments, to determine the slice support of neighboring cells, the processor 905 may determine that a particular neighboring cell that is not included in the list of PCIs supports connectivity to the respective slice group using the respective frequency.

In certain embodiments, the processor 905 controls the transceiver 925 to receive the at least one frequency and at least one slice group corresponding to the at least one frequency in dedicated RRC signaling. In other embodiments, the processor 905 controls the transceiver 925 to receive the at least one frequency and at least one slice group corresponding to the at least one frequency in broadcast RRC signaling.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to identifying slice support information of a neighbor cell. For example, the memory 910 may store parameters, configurations, and the like as described above. In certain embodiments, the memory 910 also stores program code and related data, such as an operating system or other controller algorithms operating on the user equipment apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 920 may include a wearable display separate from, but communicatively coupled to, the rest of the user equipment apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 communicates with one or more network functions of a mobile communication network via one or more access networks. The transceiver 925 operates under the control of the processor 905 to transmit messages, data, and other signals and also to receive messages, data, and other signals. For example, the processor 905 may selectively activate the transceiver 925 (or portions thereof) at particular times in order to send and receive messages.

The transceiver 925 includes at least one transmitter 930 and at least one receiver 935. One or more transmitters 930 may be used to provide UL communication signals to a base station unit 121, such as the UL transmissions described herein. Similarly, one or more receivers 935 may be used to receive DL communication signals from the base station unit 121, as described herein. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. In one embodiment, the transceiver 925 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 925, transmitters 930, and receivers 935 may be implemented as physically separate components that access a shared hardware resource and/or software resource, such as for example, the network interface 940.

In various embodiments, one or more transmitters 930 and/or one or more receivers 935 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 930 and/or one or more receivers 935 may be implemented and/or integrated into a multi-chip module. In some embodiments, other components such as the network interface 940 or other hardware components/circuits may be integrated with any number of transmitters 930 and/or receivers 935 into a single chip. In such embodiment, the transmitters 930 and receivers 935 may be logically configured as a transceiver 925 that uses one or more common control signals or as modular transmitters 930 and receivers 935 implemented in the same hardware chip or in a multi-chip module.

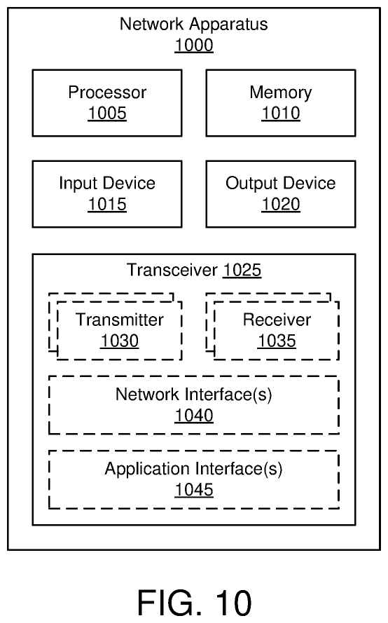

FIG. 10 depicts a network apparatus 1000 that may be used for identifying slice support information of a neighbor cell, according to embodiments of the disclosure. In one embodiment, the network apparatus 1000 may be one implementation of a network endpoint, such as the base station unit 121 and/or RAN node 210, as described above. Furthermore, the network apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the network apparatus 1000 may not include any input device 1015 and/or output device 1020. In various embodiments, the network apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. Here, the transceiver 1025 communicates with one or more remote units 105. Additionally, the transceiver 1025 may support at least one network interface 1040 and/or application interface 1045. The application interface(s) 1045 may support one or more APIs. The network interface(s) 1040 may support 3GPP reference points, such as Uu, N1, N2 and N3. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a CPU, a GPU, an auxiliary processing unit, a FPGA, or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the network apparatus 1000 is a RAN node (e.g., gNB) that communicates with one or more UEs, as described herein. In such embodiments, the processor 1005 controls the network apparatus 1000 to perform the above-described RAN behaviors. When operating as a RAN node, the processor 1005 may include an application processor (also known as “main processor”) which manages application-domain and operating system (“OS”) functions and a baseband processor (also known as “baseband radio processor”) which manages radio functions.

In various embodiments, via the transceiver 1025, the processor 1005 transmits an indication of at least one frequency and at least one slice group corresponding to (e.g., each of) the at least one frequency and broadcasts, for each of the at least one frequency, a list of PCIs supporting a combination of a respective frequency and a respective slice group. Here, the list of PCIs comprises one of a list of allowed cells or a list of blocked cells.

In some embodiments, the list of allowed cells indicates that the list of PCIs support connectivity to the respective slice group using the respective frequency. In certain embodiments, a particular neighboring cell that is not included in the list of PCIs does not support connectivity to the respective slice group using the respective frequency.

In some embodiments, the list of blocked cells indicates that the list of PCIs does not support connectivity to the respective slice group using the respective frequency. In certain embodiments, a particular neighboring cell that is not included in the list of PCIs supports connectivity to the respective slice group using the respective frequency.

In certain embodiments, the processor 1005 controls the transceiver 1025 to transmit the indication of at least one frequency and at least one slice group corresponding to the at least one frequency via dedicated RRC signaling. In other embodiments, the processor 1005 controls the transceiver 1025 to transmit the indication of at least one frequency and at least one slice group corresponding to the at least one frequency via broadcast RRC signaling.

The memory 1010, in one embodiment, is a computer readable storage medium. In some embodiments, the memory 1010 includes volatile computer storage media. For example, the memory 1010 may include a RAM, including DRAM, SDRAM, and/or SRAM. In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to identifying slice support information of a neighbor cell. For example, the memory 1010 may store parameters, configurations, and the like, as described above. In certain embodiments, the memory 1010 also stores program code and related data, such as an operating system or other controller algorithms operating on the network apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the network apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 includes at least one transmitter 1030 and at least one receiver 1035. One or more transmitters 1030 may be used to communicate with the UE, as described herein. Similarly, one or more receivers 1035 may be used to communicate with network functions in the PLMN and/or RAN, as described herein. Although only one transmitter 1030 and one receiver 1035 are illustrated, the network apparatus 1000 may have any suitable number of transmitters 1030 and receivers 1035. Further, the transmitter(s) 1030 and the receiver(s) 1035 may be any suitable type of transmitters and receivers.

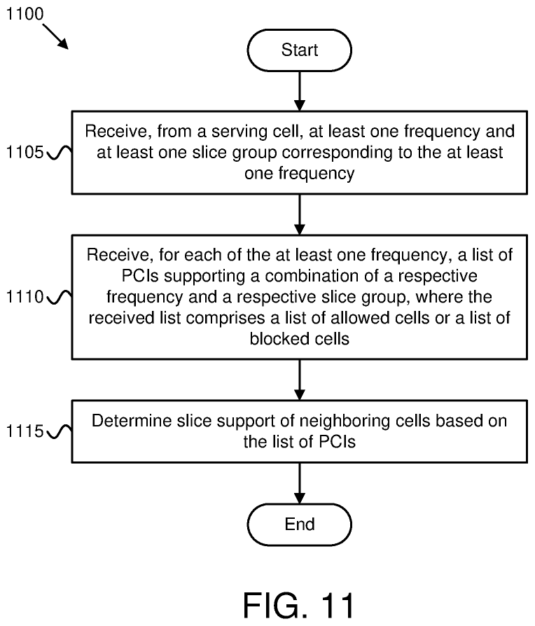

FIG. 11 depicts one embodiment of a method 1100 for identifying slice support information of a neighbor cell, according to embodiments of the disclosure. In various embodiments, the method 1100 is performed by a communication device, such as a remote unit 105, a UE 205, and/or the user equipment apparatus 900, as described above. In some embodiments, the method 1100 is performed by a processor, such as a microcontroller, a microprocessor, a CPU, a GPU, an auxiliary processing unit, a FPGA, or the like.

The method 1100 includes receiving 1105, from a serving cell, an indication of at least one frequency and at least one slice group corresponding to (e.g., each of) the at least one frequency. The method 1100 includes receiving 1110, for each of the at least one frequency, a list of PCIs) supporting a combination of a respective frequency and a respective slice group, where the received list comprises one of a list of allowed cells or a list of blocked cells. The method 1100 includes determining 1115 slice support of neighboring cells based on the list of PCIs.

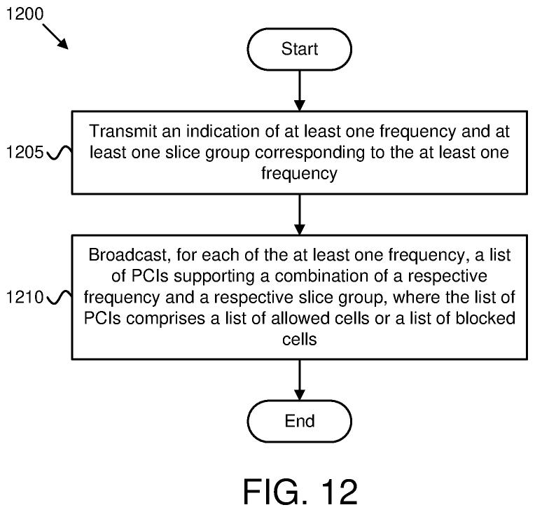

FIG. 12 depicts one embodiment of a method 1200 for identifying slice support information of a neighbor cell, according to embodiments of the disclosure. In various embodiments, the method 1200 is performed by a network entity, such as a base unit 121, the RAN node 210, and/or the network apparatus 1000, as described above. In some embodiments, the method 1200 is performed by a processor, such as a microcontroller, a microprocessor, a CPU, a GPU, an auxiliary processing unit, a FPGA, or the like.

The method 1200 includes transmitting 1205 an indication of at least one frequency and at least one slice group corresponding to (e.g., each of) the at least one frequency. The method 1200 includes broadcasting 1210, for each of the at least one frequency, a list of PCIs supporting a combination of a respective frequency and a respective slice group, where the list of PCIs comprises one of a list of allowed cells or a list of blocked cells.

Disclosed herein is a first apparatus for identifying slice support information of a neighbor cell, according to embodiments of the disclosure. The first apparatus may be implemented by a communication device, such as a remote unit 105, a UE 205, and/or the user equipment apparatus 900, as described above. The first apparatus includes a processor coupled to a memory, the processor configured to cause the first apparatus to: A) receive, from a serving cell, an indication of at least one frequency and at least one slice group corresponding to (e.g., each of) the at least one frequency; B) receive, for each of the at least one frequency, a list of PCIs supporting a combination of a respective frequency and a respective slice group, where the received list comprises one of a list of allowed cells or a list of blocked cells; and C) determine slice support of neighboring cells based on the list of PCIs.

In some embodiments, the list of allowed cells indicates that the list of PCIs supports connectivity to the respective slice group using the respective frequency. In certain embodiments, to determine the slice support of neighboring cells, the instructions are further executable by the processor to cause the first apparatus to determine that a particular neighboring cell that is not included in the list of PCIs does not support connectivity to the respective slice group using the respective frequency.

In some embodiments, the list of blocked cells indicates that the list of PCIs does not support connectivity to the respective slice group using the respective frequency. In certain embodiments, to determine the slice support of neighboring cells, the instructions are further executable by the processor to cause the first apparatus to determine that a particular neighboring cell that is not included in the list of PCIs supports connectivity to the respective slice group using the respective frequency.

In some embodiments, the instructions are further executable by the processor to cause the first apparatus to receive the at least one frequency and at least one slice group corresponding to the at least one frequency in dedicated RRC signaling or in broadcast RRC signaling.

Disclosed herein is a first method for identifying slice support information of a neighbor cell, according to embodiments of the disclosure. The first method may be performed by a communication device, such as a remote unit 105, a UE 205, and/or the user equipment apparatus 1000, as described above. The first method includes receiving, from a serving cell, an indication of at least one frequency and at least one slice group corresponding to (e.g., each of) the at least one frequency and receiving, for each of the at least one frequency, a list of PCIs supporting a combination of a respective frequency and a respective slice group, where the received list comprises one of a list of allowed cells or a list of blocked cells. The first method includes determining slice support of neighboring cells based on the list of PCIs.

In some embodiments, the list of allowed cells indicates that the list of PCIs support connectivity to the respective slice group using the respective frequency. In certain embodiments, determining the slice support of neighboring cells comprises determining that a particular neighboring cell that is not included in the list of PCIs does not support connectivity to the respective slice group using the respective frequency.

In some embodiments, the list of blocked cells indicates that the list of PCIs does not support connectivity to the respective slice group using the respective frequency. In certain embodiments, determining the slice support of neighboring cells comprises determining that a particular neighboring cell that is not included in the list of PCIs supports connectivity to the respective slice group using the respective frequency.

In some embodiments, receiving the at least one frequency and at least one slice group corresponding to the at least one frequency comprises receiving one of dedicated RRC signaling, broadcast RRC signaling, or a combination thereof.

Disclosed herein is a second apparatus for identifying slice support information of a neighbor cell, according to embodiments of the disclosure. The second apparatus may be implemented by a network entity, such as a base station unit 121, the RAN node 210, and/or the network apparatus 1100, as described above. The second apparatus includes a processor coupled to a memory, the processor configured to cause the second apparatus to: A) transmit an indication of at least one frequency and at least one slice group corresponding to (e.g., each of) the at least one frequency; and B) broadcast, for each of the at least one frequency, a list of PCIs supporting a combination of a respective frequency and a respective slice group, where the list of PCIs comprises one of a list of allowed cells or a list of blocked cells.

In some embodiments, the list of allowed cells indicates that the list of PCIs support connectivity to the respective slice group using the respective frequency. In certain embodiments, a particular neighboring cell that is not included in the list of PCIs does not support connectivity to the respective slice group using the respective frequency.

In some embodiments, the list of blocked cells indicates that the list of PCIs does not support connectivity to the respective slice group using the respective frequency. In certain embodiments, a particular neighboring cell that is not included in the list of PCIs supports connectivity to the respective slice group using the respective frequency.

In some embodiments, the instructions are further executable by the processor to cause the second apparatus to transmit the indication of at least one frequency and at least one slice group corresponding to the at least one frequency via dedicated RRC signaling or via broadcast RRC signaling.

Disclosed herein is a second method for identifying slice support information of a neighbor cell, according to embodiments of the disclosure. The second method may be performed by a network entity, such as a base station unit 121, the RAN node 210, and/or the network apparatus 1100, as described above. The second method includes transmitting an indication of at least one frequency and at least one slice group corresponding to (e.g., each of) the at least one frequency. The second method includes broadcasting, for each of the at least one frequency, a list of PCIs supporting a combination of a respective frequency and a respective slice group, where the list of PCIs comprises one of a list of allowed cells or a list of blocked cells.

In some embodiments, the list of allowed cells indicates that the list of PCIs support connectivity to the respective slice group using the respective frequency. In certain embodiments, a particular neighboring cell that is not included in the list of PCIs does not support connectivity to the respective slice group using the respective frequency.

In some embodiments, the list of blocked cells indicates that the list of PCIs does not support connectivity to the respective slice group using the respective frequency. In certain embodiments, a particular neighboring cell that is not included in the list of PCIs supports connectivity to the respective slice group using the respective frequency.

In some embodiments, transmitting the indication of at least one frequency and at least one slice group corresponding to the at least one frequency comprises transmitting the indication via dedicated RRC signaling or via broadcast RRC signaling.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (UE) for wireless communication, comprising:
at least one memory; and
at least one processor coupled with the at least one memory and configured to cause the UE to:
receive, from a serving cell, an indication of at least one frequency and at least one slice group corresponding to the at least one frequency;
receive, for each of the at least one frequency, a list of Physical Cell Identities (PCIs) associated with a respective slice group,
wherein the received list of PCIs comprises a list of allowed cells or a list of blocked cells; and
determine slice support of a set of neighboring cells based on the list of PCIs.

2. The UE of claim 1, wherein the list of allowed cells indicates that each cell in the list of allowed cells supports connectivity to the respective slice group using a respective frequency.

3. The UE of claim 2, wherein to determine the slice support of the set of neighboring cells, the at least one processor is configured to cause the UE to determine that a particular neighboring cell that is not included in the list of allowed cells PCIs does not support connectivity to the respective slice group using the respective frequency.

4. The UE of claim 1, wherein the list of blocked cells indicates that each cell in the list of blocked cells does not support connectivity to the respective slice group using a respective frequency.

5. The UE of claim 4, wherein to determine the slice support of the set of neighboring cells, the at least one processor is configured to cause the UE to determine that a particular neighboring cell that is not included in the list of blocked cells supports connectivity to the respective slice group using the respective frequency.

6. The UE of claim 1, wherein the at least one processor is configured to cause the UE to receive the indication of the at least one frequency and the at least one slice group corresponding to the at least one frequency in dedicated Radio Resource Control (RRC) signaling or in broadcast RRC signaling.

7. A processor for wireless communication, comprising:
at least one controller coupled with at least one memory and configured to cause the processor to:
receive, from a serving cell, an indication of at least one frequency and at least one slice group corresponding to the at least one frequency;
receive, for each of the at least one frequency, a list of Physical Cell Identities (PCIs) associated with a respective slice group,
wherein the received list of PCIs comprises a list of allowed cells or a list of blocked cells; and
determine slice support of a set of neighboring cells based on the list of PCIs.

8. The processor of claim 7, wherein the list of allowed cells indicates that each cell in the list of allowed cells supports connectivity to the respective slice group using a respective frequency.

9. The processor of claim 8, wherein to determine the slice support of the set of neighboring cells, the at least one controller is configured to cause the processor to determine that a particular neighboring cell that is not included in the list of allowed cells does not support connectivity to the respective slice group using the respective frequency.

10. The processor of claim 7, wherein the list of blocked cells indicates that each cell in the list of blocked cells does not support connectivity to the respective slice group using a respective frequency.

11. The processor of claim 10, wherein to determine the slice support of the set of neighboring cells, the at least one controller is configured to cause the processor to determine that a particular neighboring cell that is not included in the list of blocked cells supports connectivity to the respective slice group using the respective frequency.

12. The processor of claim 7, wherein to receive the indication of the at least one frequency and the at least one slice group corresponding to the at least one frequency, the at least one controller is configured to cause the processor to receive dedicated Radio Resource Control (RRC) signaling, broadcast RRC signaling, or a combination thereof.

13. A base station for wireless communication, comprising:
at least one memory; and
at least one processor coupled with the at least one memory and configured to cause the base station to:
transmit an indication of at least one frequency and at least one slice group corresponding to the at least one frequency; and
broadcast, for each of the at least one frequency, a list of Physical Cell Identities (PCIs) associated with a respective slice group,
wherein the list of PCIs comprises a list of allowed cells or a list of blocked cells.

14. The base station of claim 13, wherein the list of allowed cells indicates that the list of PCIs support connectivity to the respective slice group using the respective frequency, and wherein a particular neighboring cell that is not included in the list of allowed cells does not support connectivity to the respective slice group using the respective frequency.

15. The base station of claim 13, wherein the list of blocked cells indicates that the list of PCIs does not support connectivity to the respective slice group using the respective frequency, and wherein a particular neighboring cell that is not included in the list of blocked cells supports connectivity to the respective slice group using the respective frequency.

16. The base station of claim 13, wherein to transmit the indication of the at least one frequency and the at least one slice group corresponding to the at least one frequency, the at least one controller is configured to cause the processor to transmit dedicated Radio Resource Control (RRC) signaling, broadcast RRC signaling, or a combination thereof.

17. A method performed by a base station, the method comprising:
transmitting an indication of at least one frequency and at least one slice group corresponding to the at least one frequency; and
broadcasting, for each of the at least one frequency, a list of Physical Cell Identities (PCIs) associated with a respective slice group,
wherein the list of PCIs comprises a list of allowed cells or a list of blocked cells.

18. The method of claim 17, wherein the list of allowed cells indicates that the list of PCIs support connectivity to the respective slice group using the respective frequency, and wherein a particular neighboring cell that is not included in the list of allowed cells does not support connectivity to the respective slice group using the respective frequency.

19. The method of claim 17, wherein the list of blocked cells indicates that the list of PCIs does not support connectivity to the respective slice group using the respective frequency, and wherein a particular neighboring cell that is not included in the list of blocked cells supports connectivity to the respective slice group using the respective frequency.

20. The method of claim 17, wherein transmitting the indication of the at least one frequency and the at least one slice group corresponding to the at least one frequency comprises transmitting dedicated Radio Resource Control (RRC) signaling, broadcast RRC signaling, or a combination thereof.
